(19) United States
(12) Patent Application Publication
(10) Pub. No.: US 2018/0334956 A1
(43) Pub. Date: Nov. 22, 2018

(54) ROD FOR A VARIABLE COMPRESSION RATIO ENGINE

(71) Applicant: MCE 5 Development, Lyon (FR)

(72) Inventors: Philippe Dury, Miribel (FR); Yves Miehe, Lyon (FR)

(21) Appl. No.: 15/776,730

(22) PCT Filed: Nov. 17, 2016
(86) PCT No.: PCT/FR2016/052984

§ 371 Date: May 16, 2018

(30) Foreign Application Priority Data
Nov. 17, 2015 (FR) 1561052

(51) Int. Cl. F02B 75/04; F02D 15/02; F16C 7/06; F15B 15/14

(52) U.S. Cl. CPC F02B 75/045; F02D 15/02; F16C 7/06; F16C 2360/22; F15B 15/1419; F02D 2700/03; F15B 15/149

(57) ABSTRACT

A rod (1), the length of which is variable, is used for adjusting the compression ratio of an engine. The rod comprises a cylinder rigidly connected to a first end of the rod; a piston that is movable within the cylinder, and is rigidly connected to the second end of the rod, and defines, in the cylinder, a first hydraulic chamber referred to as the “high-pressure” hydraulic chamber, capable of transmitting compression forces, and a second hydraulic chamber referred to as the “low-pressure” hydraulic chamber, capable of transmitting tensile forces; at least one conduit calibrated to enable fluid to flow between the low-pressure chamber and the high-pressure chamber; and return means to bring the rod back to its nominal length, wherein the cross-sections of the low-pressure hydraulic chamber and the high-pressure hydraulic chamber are equal.

### CROSS-REFERENCE TO RELATED APPLICATIONS

This application is a national phase entry under 35 U.S.C. § 371 of International Patent Application PCT/FR2016/052984, filed Nov. 17, 2016, designating the United States of America and published as International Patent Publication WO 2017/085409 A1 on May 26, 2017, which claims the benefit under Article 8 of the Patent Cooperation Treaty to French Patent Application Serial No. 1561052, filed Nov. 17, 2015.

### TECHNICAL FIELD

The application relates to a rod of a variable compression ratio engine.

### BACKGROUND

By way of introduction, it should be noted that a rod of an internal combustion engine is associated at its base with the bearing of a combustion piston and at its head with the bearing of a crankshaft. These two bearings are generally parallel axes. As shown respectively in FIGS. 1A and 1B, the function of the rod is to transmit the movement of translation of the piston, from “top dead center” to “bottom dead center,” to the movement of rotation of the crankshaft. The rod also maintains the angular position of the piston along the axis of translation thereof.

Multiple solutions are known in the state of the art for adjusting the compression ratio and/or the displacement of an internal combustion engine.

It should be noted that the compression ratio of an internal combustion engine corresponds to the ratio between the volume of the combustion chamber when the piston is at its bottom dead center; and the volume of the combustion chamber when the piston is at its top dead center. All else being equal, the choice of rod length determines the engine's compression ratio.

It should be noted that the compression ratio of an internal combustion engine corresponds to the ratio between the volume of the combustion chamber when the piston is at its bottom dead center; and the volume of the combustion chamber when the piston is at its top dead center. All else being equal, the choice of rod length determines the engine's compression ratio.

It is generally accepted that the adaptation of the compression ratio of an engine to its load greatly improves the energy efficiency of the engine. For example, it is sometimes desired to vary the compression ratio between about a value of 12 in the absence of load to a value of about 8 at full load.

It should be noted that a complete engine cycle of a four-stroke engine consists of a fresh gas intake stroke, followed by a compression stroke, a combustion-expansion stroke, and finally an exhaust stroke. These strokes are of substantially equal extent, distributed over a 720° rotation of the crankshaft. The engine load is then defined as the fictitious constant pressure exerted on the piston crown during the combustion-expansion part of a cycle (the pressure exerted on the piston crown during the complementary part of the cycle being considered as null) resulting in a power equivalent to that developed by the engine during a complete cycle. This pressure is at most of the order of 10 bar for an ordinary atmospheric engine, and can commonly rise to values of 20 to 30 bar for a supercharged engine.

As for the displacement, it corresponds to the volume generated by the piston sliding between a top dead center and a bottom dead center in the cylinder of the engine. A variable displacement is obtained by varying the stroke of the piston in the cylinder. The choice of rod length has no impact on displacement. The variation in displacement must be of great amplitude to have a noticeable effect on energy efficiency, which is difficult to implement from a technological standpoint.

U.S. Pat. No. 4,111,164 thus aims to vary the displacement of an engine according to the load applied to it. This document discloses a rod consisting of a spring combined with a hydraulic chamber so as to rigidly couple a piston to the crankshaft of the engine when it is not subjected to a load; and elastically coupling the piston to the crankshaft when the engine is under heavy load. For the latter heavy load situation, the rod acts as a shock absorber, compressing and expanding according to the momentary value of the forces developing during an engine cycle. U.S. Pat. No. 4,111,164 thus discloses a constant displacement with the load during the intake stroke, while the displacement is increased during the combustion stroke when the load increases. However, the combustion forces partly absorbed in the hydraulic chamber of the rod are not restored, which makes the solution particularly inefficient.

This solution therefore does not allow adjusting the compression ratio according to the load applied during one or a succession of engine cycles. The behavior of this rod is particularly sensitive to engine speed. The solution proposed in U.S. Pat. No. 4,111,164 also leads to intense stress on the mechanical components of the rod (spring, hydraulic chamber) during engine operation, which accelerates their wear and reduces the reliability of the system.

Moreover, the hydraulic chamber of the solution presented in U.S. Pat. No. 4,111,164 is particularly sensitive to changes in temperature of the hydraulic fluid, which, combined with the sensitivity to engine speed, makes the behavior of the rod particularly unpredictable.

The document R0111863 describes an internal combustion engine consisting of a movable top block and a stationary bottom block opposite the chassis of a vehicle. The top block is free to rotate along a lateral axis linking the top block to the bottom block. As the engine load increases, the average effective pressure in the cylinder increases and causes the top block to swing around the lateral axis. As a consequence, one cylinder volume is added to the volume of the combustion chamber, thus causing a decrease in the volumetric compression ratio.

The solution proposed in this document requires the design and manufacture of an articulated engine block that does not correspond to a standard combustion engine architecture, consisting of a stationary engine block, which requires a complete re-design of most interface elements between the engine and the chassis of the vehicle. The elements connecting to the upper part of the engine (air intake line, gas intake line, exhaust line, distributor, etc.) must be adapted to tolerate the movability of the upper part of the engine.

Other documents, such as WO 2013/092364, describe rods of controlled length, used to set the compression ratio of an internal combustion engine (without affecting the displacement). These solutions require the presence of an active control system of the rod length via an external control system (hydraulic piston, electric motor) which is generally complex, source of energy losses and unreliable. Moreover, the compression ratio is not continuously controlled and the attainable range of compression ratios is often very limited. This is particularly the case of the solution proposed in the aforementioned document, which only provides two rod lengths.

### BRIEF SUMMARY

The present disclosure aims to remedy at least some of the drawbacks of the prior art presented above. In particular, the disclosure aims to make the behavior of a rod for a variable compression ratio engine independent of the engine's operating temperature.

To reach this goal, the embodiments disclosed herein provide a rod, the length of which is variable, for adjusting the compression ratio of an engine, the rod having a nominal length and being likely to be subjected to tensile and compressive forces along its longitudinal axis, the rod comprising the following:
a cylinder rigidly connected with a first end of the rod;
a piston, which is movable in the cylinder, is rigidly connected with the second end of the rod, and defines, in the cylinder, a first hydraulic chamber referred to as the “high-pressure” hydraulic chamber capable of transmitting compression forces and a second hydraulic chamber referred to as the “low-pressure” hydraulic chamber capable of transmitting tensile forces;
at least one conduit calibrated to enable hydraulic fluid to flow between the low-pressure chamber and the high-pressure chamber; and
mechanical return means tending to bring the rod back to its nominal length.

The rod is remarkable in that the low-pressure hydraulic chamber and the high-pressure hydraulic chamber have equivalent cross sections. This ensures that the stress behavior of the rod remains substantially independent of the temperature of the hydraulic fluid.

According to other advantageous and non-limiting characteristics of the disclosure, taken either separately or in combination:
the cylinder has a circular or oval cross section;
the cylinder and/or the piston is provided with a means for rotational indexing of the piston with respect to the cylinder;
the mechanical return means include a spring;
the spring is placed in the high-pressure hydraulic chamber;
the spring is preloaded;
the rod further includes means for filling the cylinder with a hydraulic fluid, e.g., arranged to introduce the hydraulic fluid into the low-pressure chamber;
the filling means include a non-return valve;
the rod further comprises means for discharging any excess of hydraulic fluid in the cylinder in order to limit the pressure developing within it;
the discharging means includes a non-return valve;
the calibrated conduit is formed in the piston or in the cylinder body; and
the calibrated conduit is formed by the existing gap between the piston and the cylinder.
The rod includes the following:
   at least one calibrated conduit, referred to as “tensile” calibrated conduit, that only allows a flow to take place from the low-pressure hydraulic chamber to the high-pressure hydraulic chamber; and
   at least one calibrated conduit, referred to as “compressive” calibrated conduit, which only allows a flow to take place from the high-pressure hydraulic chamber to the low-pressure hydraulic chamber;
the compressive calibrated conduit only allows a flow to take place when the pressure in the high-pressure hydraulic chamber exceeds the pressure in the low-pressure hydraulic chamber by a specified value;
the rod has at least two compressive calibrated conduits;
the calibrated conduit is configured to promote a turbulent flow of the hydraulic fluid;
the rod comprises at least one valve formed of a movable part whose direction of mobility is parallel to the base and head axes of the rod;
the rod comprises at least one valve formed of a movable part whose direction of mobility is located in a plane comprising the main and transverse axes of the rod, the mass of the movable part of the valve being set to a specified quantity; and
the characteristics of the mechanical return means and of the calibrated conduit are selected so that the rod forms a highly-damped oscillating system.

According to another aspect, the disclosure also relates to a variable compression ratio engine comprising the variable-length rod. According to other advantageous and non-restrictive characteristics, taken either separately or in combination:
the engine includes a device for determining the compression ratio; and
the device for determining the compression ratio comprises a target arranged on the variable-length rod and a sensor placed opposite the engine.

### BRIEF DESCRIPTION OF THE DRAWINGS

The disclosure will be better understood upon reading the following description of the specific although not restrictive embodiments of the disclosure and while referring to the appended figures wherein:

FIGS. 1A and 1B show the top dead center and bottom dead center positions of a piston of a conventional combustion engine;

FIG. 2 shows the forces applied to a rod during an engine cycle at maximum load and at two different engine speeds;

FIG. 3 shows the maximum amplitude of the compression forces during an engine cycle according to its load;

FIG. 4 shows the evolution of the inertia forces during an engine cycle, at various engine speeds;

FIG. 5 shows the block diagram of a rod according to the disclosure;

FIG. 6 shows the means for sealing the rod piston, according to a specific mode of implementation of the disclosure;

FIG. 7a shows a graphic representation of the relationship linking the length of a rod to the load of an engine, a rod for which the condition of equivalent cross section is not met, for a rise in temperature of the hydraulic fluid;

FIGS. 7b to 7d show three rod configurations for which the condition of equivalent cross section is met;

FIG. 8a shows a target engine load-compression ratio behavior law of an engine;

FIG. 8b shows the target rod length according to the engine load, to reproduce the behavior law of FIG. 8a;

FIG. 8c shows the damping laws corresponding to the maximum elongation speed of the rod according to the amplitude of a constant force applied thereto, for three different rod configurations;

FIG. 9 shows a first example of a rod according to the disclosure;

FIG. 9a shows in detail the calibrated conduit of the example in FIG. 9;

FIG. 10 shows the behavior of the rod of the first example when it is put into operation in an engine;

FIG. 11 shows a second example of a rod according to the disclosure;

FIGS. 11a and 11b show in detail the calibrated conduits of the example in FIG. 11;

FIG. 12 shows the behavior of the rod of the second example when it is put into operation in an engine.

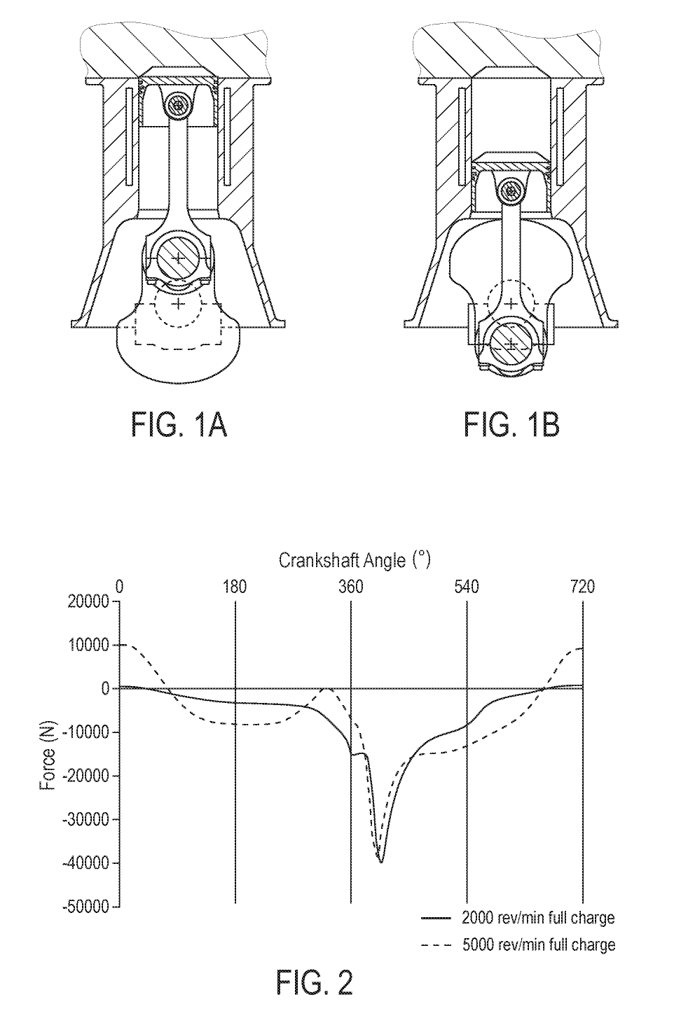

### DETAILED DESCRIPTION

A rod is subjected to tensile and compressive forces during the engine's operating cycles. These forces have two sources: the forces due to the combustion of the mixture in the combustion cylinder and the inertia forces due to the engine speed. FIG. 2 shows, by way of example, the forces applied to a rod during an engine cycle at maximum load and at two different engine speeds.

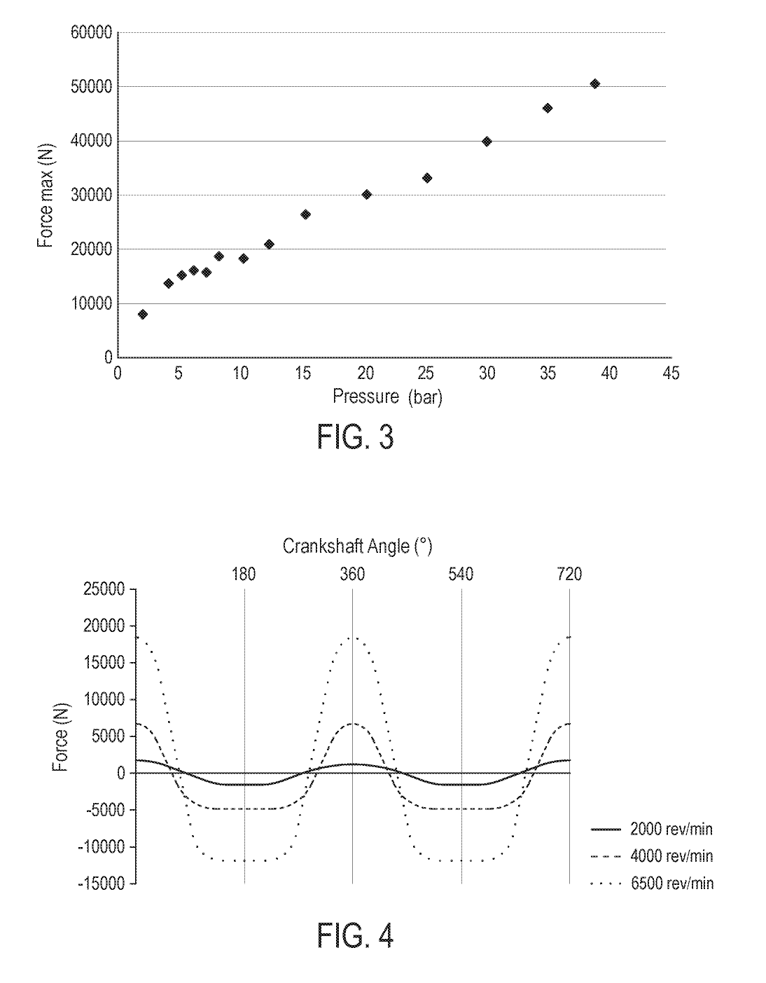

The combustion forces exclusively result in compressive stresses on the rod. The maximum amplitude of these forces is substantially proportional to the engine load as shown in FIG. 3, by way of example.

The inertia forces result in successive tensile and compressive stresses on the rod during an engine cycle. The maximum amplitude of the inertia forces is essentially proportional to the square of the engine speed (i.e., its rotational speed). This is illustrated by way of example in FIG. 4.

During an engine cycle or a plurality of engine cycles, and if friction is ignored, the work that the inertia forces applied to the rod develop is null, since the momentary compressive inertia forces and momentary tensile inertia forces compensate each other on average over the entire cycle, even though their amplitudes are maximum and their curve shapes are different.

Accordingly, over an engine cycle or a plurality of engine cycles, the work of the combined forces that apply to the rod substantially corresponds to the work of the combustion forces, which are representative of the engine load as previously specified in relation to the description of FIG. 3.

The disclosure is based on these observations to provide a variable-length rod according to the engine load, i.e., according to the average combustion forces. This variation in rod length makes it possible to autonomously adjust (i.e., without needing to implement an active control system of the rod length) the compression ratio of the engine to its load, without substantially modifying the displacement.

“Average forces” refers to the average of the forces that apply during one cycle or a plurality of cycles, more specifically engine cycles.

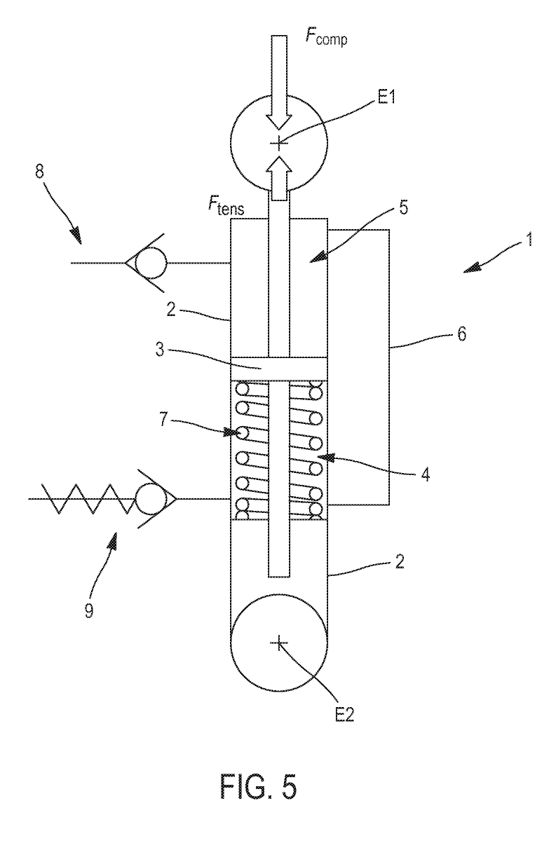

A rod 1 according to the disclosure and as shown schematically in FIG. 5, comprises the following:
cylinder 2 rigidly connected with a first end E1 of the rod; and
movable piston 3 in the cylinder 2 and rigidly connected with the second end E2 of the rod.

Each end of the rod 1 may carry a bearing, one being intended to be connected to the combustion piston and the other to the crankshaft. The rod length refers to the interaxial distance between the two bearings. The displacement of the piston 3 in the cylinder 2 makes it possible to adjust the length of the rod 1 between a first limit stop (minimum length of the rod) and a second limit stop (maximum or nominal length of the rod).

The piston 3 defines, in the cylinder 2, a first hydraulic chamber 4, referred to as “high-pressure” hydraulic chamber, capable of transmitting the compressive forces Fcomp applied to the rod 1 along its longitudinal axis and a second hydraulic chamber 5, referred to as “low-pressure” hydraulic chamber capable of transmitting the tensile forces Ftens applied to the rod 1 along its longitudinal axis. These two “high-pressure” 4 and “low-pressure” 5 chambers are in fluid communication, via at least one calibrated conduit 6.

The movement of the piston 3, which leads the length of the rod 1 to be adjusted, is generated by the tensile and compressive forces applied to the rod 1 and is authorized (within the limits provided by the stops) by the flow of fluid from one chamber to another through the calibrated conduit 6. When there is no flow, the rod 1 behaves like a rigid body, the movement of the piston 3 in the cylinder 2 being limited to the compressibility of the hydraulic fluid pressurized by the tensile and/or compressive forces.

The dynamics of the flow between the two chambers 4, 5 therefore conditions the speed of adjustment of the rod 1 length to the momentary forces applied.

According to the disclosure, these dynamics are chosen (in particular by the size of the calibrated conduit(s) 6) so as not to react, or to react with a controlled and limited amplitude, to the momentary inertia or combustion forces.

In a particularly advantageous manner, the calibrated conduit(s) 6 is (are) configured to promote a turbulent flow. As opposed to a laminar flow, in turbulent flow conditions, the relationship linking the flow rate to the pressure is much less sensitive to the temperature of the fluid. This contributes to establishing a substantially constant behavior of the rod despite the temperature variations of the hydraulic fluid (which can range from −20° C., with a cold engine under extreme temperature conditions, to 150° C. with a running engine).

As is well known per se, a turbulent flow is promoted by decreasing the ratio of the conduit length to its diameter and by hindering the entry of the hydraulic fluid into the conduit so as to create a violent transition between the chamber and the conduit (e.g., no converging inlet cones are formed between the chambers 4, 5 and the conduit 6).

According to a first configuration, the cylinder 2 of the rod and/or the piston 3 of rod are provided with sealing means preventing the flow of the hydraulic fluid from one chamber 4, 5 to another aside from the calibrated conduit(s) 6 provided for.

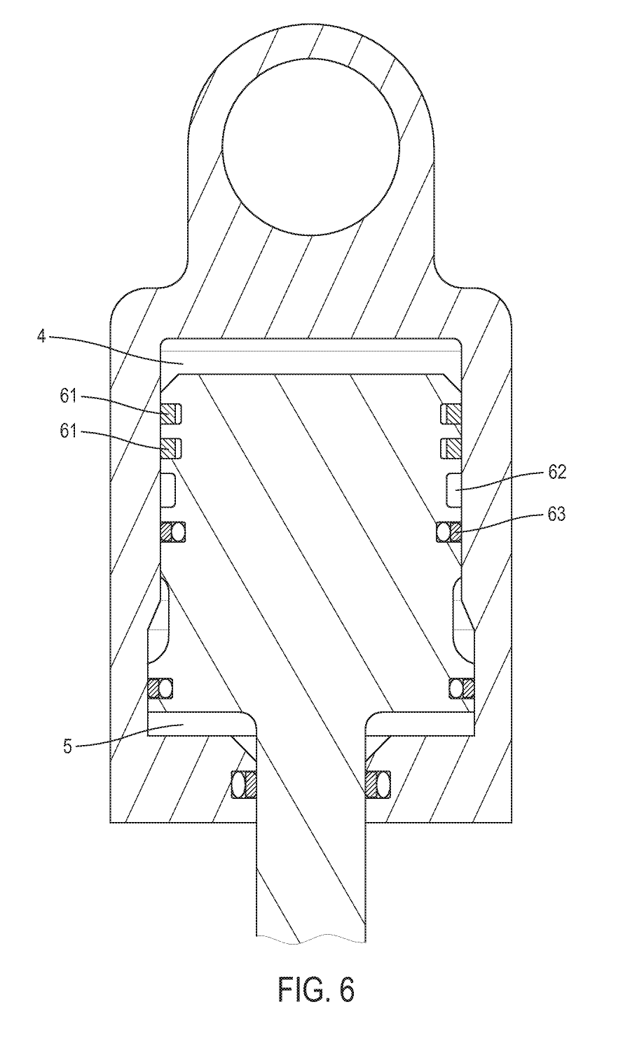

In a specific exemplary embodiment (shown in FIG. 6), these sealing means comprise the following at the level of the piston sliding face and successively from the high-pressure chamber 4 toward the low-pressure chamber 5:
one or several metal segments 61 for containing the pressure front of the fluid in the high-pressure chamber 4;
an intermediate hydraulic fluid reservoir 62; and
and a seal 63 (e.g., composite or 0-ring) sealing the assembly.

In this first configuration, the calibrated conduit 6 between the low-pressure chamber 5 and the high-pressure chamber 4 is formed in the piston 3 and/or in the cylinder 2. Advantageously, and for simple manufacturing, the calibrated conduit 6 or one of the calibrated conduits 6 between the low-pressure chamber 5 and the high-pressure chamber 4 is formed in the piston 3. Alternatively, this conduit 6 or one of these calibrated conduit 6 can be formed in the body of the cylinder 2.

According to another configuration, the rod cylinder 2 and/or the rod piston 3 are not provided with sealing means. In this case, the gap between the piston 3 and the cylinder 2 is chosen so as to allow the flow of fluid between the two chambers, and is in itself a calibrated conduit 6 between the low-pressure chamber 5 and the high-pressure chamber 4. In this configuration, at least one additional calibrated conduit 6 formed in the piston 3 and/or in the body of the cylinder 2 may be provided.

In addition, a rod 1 according to the disclosure comprises mechanical return means 7 configured to return the rod to its nominal length in the absence of external forces.

The rod 1 thus fashioned forms an oscillating system.

According to the disclosure, the calibrated conduit(s) 6 and the mechanical return means 7 are configured and/or chosen to adjust the length of the rod 1 to the average tensile and compressive forces applied to the rod 1. This adjustment may consist in reducing the length of the rod as the average compression forces increase. In other words, the characteristics of the mechanical return means (stiffness, pre-loading, etc.) and of the calibrated conduit(s) (quantity, diameter, length, nature of the flow, etc.) are chosen so that the rod forms or exhibits the behavior of a highly-damped oscillating system. It should be noted that a highly-damped oscillating system is an oscillating system whose damping factor is greater than 1.

The operation in an engine of a rod 1 according to the disclosure is described below.

When the engine is started, the rod 1 is at its nominal length, since the return means 7 lead the piston 3/cylinder 2 assembly of the rod to be placed in a mechanical stop position. The engine thus has a compression ratio defined by the nominal length of the rod when it is started.

The momentary tensile and compressive forces applied to the rod 1 at a low load, and which therefore essentially correspond to inertia forces, develop faster than the flow in the calibrated conduit 6 between the high-pressure hydraulic chamber 4 and the low-pressure hydraulic chamber 5. Furthermore, the length of the rod 1 is essentially unaffected by these forces, even if oscillations of a small amplitude may occur.

When the engine load increases, the average compressive forces become sufficient to enable the transfer of the hydraulic fluid from the high-pressure chamber 4 to the low-pressure hydraulic chamber 5. This flow leads the piston 3 to be displaced in the cylinder 2 and the rod 1 to be contracted. The compression ratio of the engine is then adjusted, in an entirely independent manner, according to the effective length of the rod 1.

Advantageously, the mechanical return means 7 comprise a spring, for example, a compression spring, arranged to exert a force tending to move the first end of the rod 1 away from its second end. The spring may be placed in the high-pressure hydraulic chamber 4 or arranged on the rod 1 outside the chamber 4.

The spring may have a stiffness that leads is to apply a force of return, which increases as the rod 1 contracts. In general terms, when the forces of return are only provided by the spring and aside from the effects of the stops or any transient effects, when the average combustion forces corresponding to the engine load balance out with the forces applied by the return means 7, the length of the rod 1 is essentially stabilized around a balance length, even if oscillations of small amplitudes may occur.

Conversely, when the engine load decreases, the hydraulic fluid tends to be transferred through the calibrated conduit 6 of the low-pressure chamber 5 to the high-pressure chamber 4, and the rod 1 tends to return to its mechanical stop corresponding to a nominal length configuration. The compression ratio of the engine is adjusted accordingly.

The stiffness of the spring is chosen so as to grant the maximum travel of the rod, between its two stops, for a selected range of loads.

The spring may be pre-loaded, i.e., when the rod 1 is at its nominal length, in the resting position, the spring applies a non-zero threshold return force. Thus, as long as the average combustion force (compressive force) remains below the threshold return force, the length of the rod 1 remains stationary at its nominal length. As will be seen later, part of the threshold return force can be provided by the hydraulic part of the rod 1. In this case, the part of the threshold return force provided by the spring may be reduced and the size of the spring may also be reduced.

According to a specific mode of implementation of the disclosure, the spring is pre-loaded to a non-zero threshold return force and its stiffness is chosen to be low, so that, for example, the variation in return force from one stop to the other does not exceed 70% of the pre-loading force. In this way, a substantially constant return force is applied to the rod 1 regardless of its length. This thus forms a rod 1 that can have two stable configurations, at its stops:
in a first configuration, the rod 1 has a first length equal to its nominal length as long as the average combustion force applied remains below the threshold return force; and
in a second configuration, the rod 1 has a length equal to its minimum length when the average combustion force applied is greater than the threshold return force.

This mode of implementation is particularly suitable for producing a simple and inexpensive rod 1 to implement a standalone “twin-rate” variable compression ratio engine. The engine has a first compression ratio imposed by the nominal length of the rod in its first configuration, at a low load, and a second compression ratio imposed by the minimum length of the rod in its second configuration, at a load exceeding a threshold load. The length of the rod 1 is well adjusted to the average tensile and compressive forces applied to it.

The cylinder 2 and the piston 3 of the rod may have a circular cross section. In this case, they are provided with indexing means 12 to prevent rotation along a longitudinal axis of the combustion piston in the combustion cylinder in order to keep the orientation of the bearings of the combustion piston and of the crankshaft parallel during the translational movement of the combustion piston. This may be a grooved structure between the piston 3 and the cylinder 2 or a pin 12 inserted in the piston 3 through an oblong opening in the cylinder 2, allowing the translational movement of the piston 3, but blocking any rotational movement. This avoids developing friction or blocking the engine at the connections with the crankshaft and/or the piston and the combustion cylinder.

Alternatively, the cylinder 2 and the piston 3 of the rod have a non-circular cross section, such as an oval cross section, which in itself prevents the risk of rotation along the longitudinal axis of these two bodies.

Generally speaking, the cylinder 2 and the piston 3 are dimensioned so as to limit the space requirement of the rod 1 and to enable its placement in a combustion engine of conventional design. However, the minimum size of the rod 1 is limited by the maximum hydraulic fluid pressure that may arise in the hydraulic chambers 4, 5. As such, an oval cross section of the cylinder 2 and of the piston 3 may sometimes be more appropriate to make up for any space requirement and pressure constraints. In any event, the surfaces subjected to the pressure of the hydraulic fluid at the level of the low-pressure chamber 5 and of the high-pressure chamber 4 are so selected that they are sufficiently large in order for the pressure that develops in one or the other chamber not to be excessive with respect to, for example, the strength of the sealing means, when the piston is subjected to maximum stress. One can, for example, choose not to exceed a pressure, in the high-pressure chamber 4, of about 400 bar to 1,000 bar for a conventional combustion engine.

The extent of the surfaces subjected to the pressure of the hydraulic fluid can be defined more precisely as the area of the surfaces in contact with this fluid projected onto a plane perpendicular to the sliding direction of the piston 3 of the rod in the cylinder 2 of the rod.

The cylinder 2 and/or the piston 3 of the rod can be provided with means for filling 8 a hydraulic fluid at the level of the high-pressure chamber 4 or of the low-pressure chamber 5. These filling means make it possible to keep the chambers filled with fluid, thus compensating for any leaks. This may be a conduit formed in the body of the rod and opening, at a first end, into the cylinder of the rod and, at its second end, at the connection between the head of the rod and the bearing of the crankshaft. As is well known per se, the hydraulic fluid can be taken from the engine at this connection and flow into the conduit of the rod body to feed the cylinder.

Preferably, the first end of the conduit opens into the low-pressure chamber 5 of the cylinder 2, which makes it possible to take advantage of the pumping effect that takes place when a compressive force is applied to the rod and to thus favor the flow of hydraulic fluid filling the cylinder 2. The conduit may be provided with a non-return valve preventing any flow out of the cylinder through this conduit, as shown schematically in FIG. 5.

In order to limit the pressure that develops in the cylinder 2 of the rod, it can be provided with discharging means 9. These means may consist of or include a simple conduit leading out of the high-pressure chamber 4 forming a constant leak, or a conduit provided with a pressure limiter, for example, in the form of a valve calibrated at a threshold pressure equal to the maximum desired pressure in the chamber.

Particularly advantageously, the low-pressure chamber 5 and the high-pressure chamber 4 have equivalent cross sections. The terms “equivalent cross sections” are used to indicate that the volume swept by the displacement of the piston 3 in one of the chambers 4, 5 is identical to the volume swept in the other chamber by the displacement of the piston 3.

The “equivalent cross section” condition is met when the surfaces subjected to the pressure on each face of the piston, projected onto a plane perpendicular to the direction of movement of the piston, are substantially equal.

For a given engine operating point, and when the piston 3 has reached its balance position, the pressure difference between the two chambers remains constant, regardless of the temperature of the hydraulic fluid. Insofar as the equivalent cross section condition is met, the balance of the forces acting on the rod is constant, regardless of the temperature of the hydraulic fluid.

The internal pressure of the chambers 4, 5 is particularly variable in combination with the expansion of the hydraulic fluid according to the temperature (which can range from −20° C. with a cold engine under extreme temperature conditions to 150° C. with a running engine). When the cross sections are not equivalent, the variability of the internal pressure would cause a variability of the forces applied to the piston 3. Consequently, the rod would have a behavior (length according to engine load) that varies with the temperature, which generally is not desired.

In other words, and if there is no calibrated non-return valve on the conduit 6, the rod 1 tends to balance out the average pressures in the high- and low-pressure chambers 4, 5 during its operation. When the cross sections are not equivalent, the average force generated by the pressure and exerted on the piston 3 is no longer null. In this case, it is proportional to the difference in cross section between the chambers 4, 5, and proportional to the average pressure prevailing in the chambers 4, 5. However, the hydraulic fluid is strongly subjected to thermal expansion. It follows that the pressure in the chambers 4, 5 may vary when the engine temperature rises. Consequently, the balance between the forces exerted by the return means 7, the combustion forces, and the hydraulic forces exerted on the piston 3 is then disturbed by the temperature, which is not desirable. Equivalent cross section conditions have the advantage of contributing to preserving a substantially constant behavior (length-load law) of the rod despite variations in temperature.

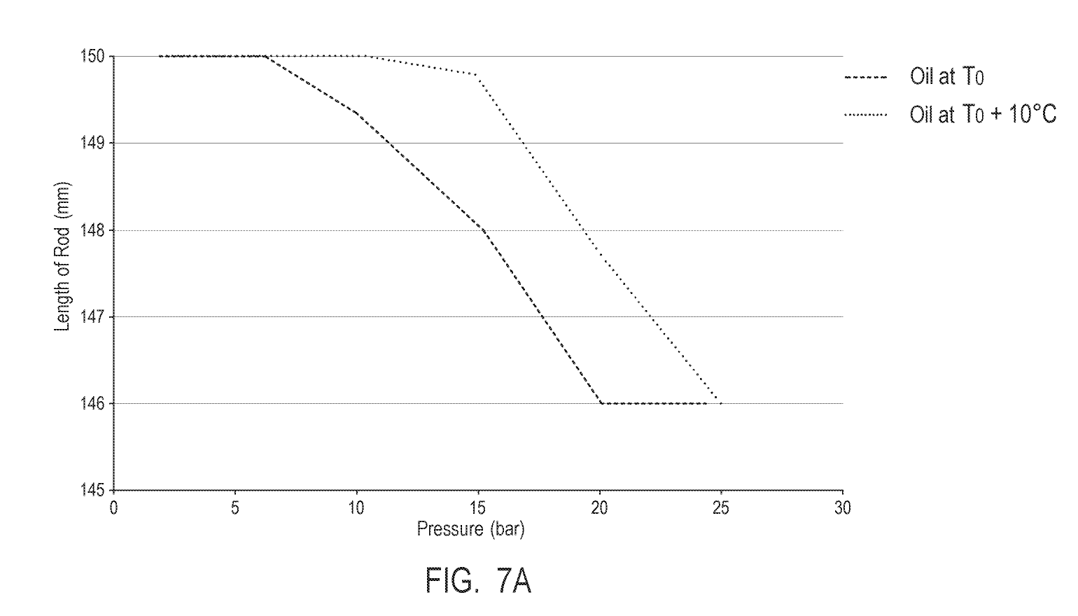

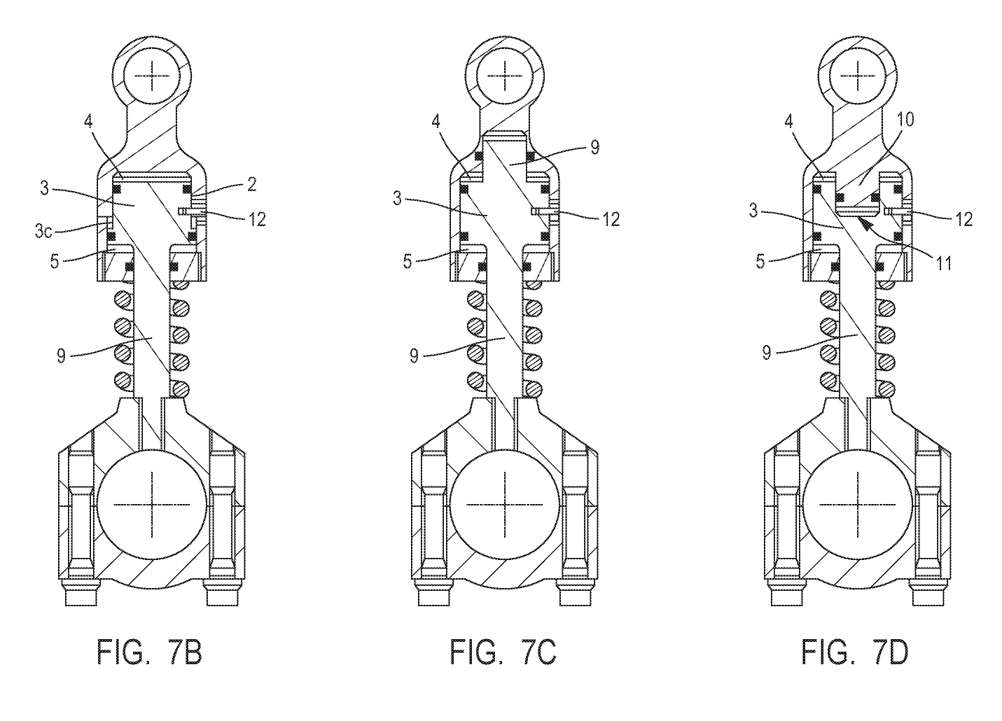

By way of example, FIG. 7a is a graphical representation of the relation linking the length of a rod, for which the condition of equivalent cross sections is not met (in this example, the surface of the high-pressure chamber is 10% larger than that of the low-pressure chamber), to the load of an engine (at 2,000 rpm), in a specific exemplary implementation of this rod. This figure shows this relation in the case of hydraulic fluids consisting of oil, commonly used for the lubrication of engines, in a first case where the oil has a reference temperature, then in a second case where the temperature of this same oil has increased by 10° C., at operating conditions that are identical to the first case. It is observed that a slight temperature rise of 10° C. leads to a very different engine load to rod length relationship, and consequently a very different engine load to compression ratio relationship, which cannot be tolerated for a reproducible and predictable operation of the engine.

Numerous configurations of the hydraulic chambers 4, 5 allow for the equivalent cross section condition to be met, and thus for the temperature effects to be limited, as shown in FIGS. 7b to 7d by way of illustration.

According to a first example, shown in FIG. 7b, this condition is met by a double-stage piston 3. In this figure, the cylinder 2 has a circular shoulder 3c so that the low-pressure chamber 5 has a diameter that is greater than that of the high-pressure chamber 4. This difference in diameter is compensated by the cross section of the shaft 9 of the piston 3 in the low-pressure chamber 5, so that in the end the volume generated by the displacement of the piston 3 in one chamber is identical to the volume generated in the other chamber by the same displacement of the piston 3.

According to a second example, shown in FIG. 7c, this condition is met by a piston 3 with a shaft opening to the outside. The shaft 9 of the piston 3 extends on either side of the piston 3 and into the volume of each of the chambers 4, 5. In this way, the condition of equivalent cross sections is also met.

According to a third example, shown in FIG. 7d, this condition is obtained by a piston 3 with a shaft opening to the inside. In this figure, the high-pressure chamber 4 has a projecting body 10 whose cross section is identical to that of the shaft 9 of the piston 3. This protruding body 10 is adjusted to a bore 11 formed in the piston 3 so as to be able to slide therein. In this way, the condition of equivalent cross sections is also met.

In order to be able to adjust the dynamics of the flow with greater flexibility, the rod 1 can include the following:
at least one calibrated conduit 6a, referred to as “tensile” calibrated conduit, which only allows a flow of hydraulic fluid from the low-pressure chamber (5) to the high-pressure chamber (4); and
at least one calibrated conduit 6b, referred to as “compressive” calibrated conduit, which only allows a flow of hydraulic fluid from the high-pressure chamber (4) to the low-pressure chamber (5).

Each of the conduits 6a, 6b may be provided with a valve to enable the flow in a single direction.

It is thus possible to adjust each of the conduits (e.g., in size) independently of one another and to enable differentiated dynamics in the adjustment of the rod length according to whether a tensile or compressive force is applied.

In a preferred variant, the calibrated compression conduit 6b only allows a flow to take place when the pressure in the high-pressure chamber 4 exceeds the pressure in the low-pressure chamber 5 by a specified value. This can be easily achieved by providing the conduit 6b with a calibrated non-return valve at a predetermined pressure difference.

By thus blocking the flow below a determined pressure differential, any compression movement of the piston 3 in the cylinder 2 of the rod is prevented as long as this pressure is not exceeded. A similar effect to that of pre-loading the return means 7 is thus obtained and these means may then be of a smaller size for an identical effect.

In one variant, the rod may have two calibrated conduits 6b for compression, one being simple and allowing a calibrated flow to take place as soon as a compressive force is applied to the rod 1, the other being provided with a calibrated non-return valve to allow a complementary flow to take place as soon as a sufficient compression force (inducing a sufficient pressure differential between the two chambers) is applied to the rod 1.

There are thus additional means for adjusting the dynamics of the flow and therefore the speed of adjustment of the rod length to the momentary forces applied to it; and, in more general terms, for controlling the relationship between compression ratio and engine load.

The valves generally consist of a movable part (such as a ball) that can travel according to a direction of mobility, and which cooperates with a seat and/or a spring. This well-known mechanism makes it possible to selectively open or close a flow passage according to the pressure difference upstream and downstream of this passage.

Advantageously, the valves that are associated with the conduits 6; 6a, 6b and/or the filling means 8 and/or the discharging means 9 of the rod 1 according to the disclosure are arranged to place the directions of mobility of their moving parts parallel to the base and head axes of the rod 1. In this configuration, the moving parts are not subjected to the acceleration of the rod 1 in their directions of mobility during the operation of the rod in an engine. This thus avoids making the engine speed dependent of the opening or closing behavior of these valves.

Alternatively, one can choose to place the direction of mobility of the moving parts of the valves (or of some of them) in a plane comprising the main axis of the rod 1, i.e., along its length, and the axis that is transversal to the rod 1, i.e., along its width. In this case, these moving parts are subjected to forces during the operation of the engine, which are proportional to their orientations in this plane, to their accelerations and to their masses, which contribute to opening or closing the valves with which they are associated. These forces may in particular develop near the top dead center and bottom dead center positions of the combustion piston (the acceleration of the rod near these positions being related to the engine speed). More specifically, when one of these valves is placed along the axis of the rod 1, the maximum acceleration related to the engine's speed of rotation, which is likely to cause the valve to open or close, is close to the peak combustion force. And when one of these valves is placed transversely to the axis of the rod 1, the maximum acceleration related to the engine's speed of rotation, which is likely to cause the valve to open or close, is far from the peak force related to combustion. It may then be advisable and useful to choose the placement along one or the other axis and, in more general terms, in the plane defined by these axes and the respective masses of the movable parts of the valves (and the stiffness of any springs with which they may cooperate) for the purpose of fine tuning the behavior (rod length-load law) of the device, in particular according to the engine speed. It then becomes possible to open or close these valves, and in particular the valves that can be associated with the calibrated conduit(s) 6, beyond a given engine speed, which offers an additional dimension for optimizing the behavior of the rod.

According to another advantageous aspect, the valves include a mechanical stop for the movable part limiting their maximum opening and allow for the flow rate to be controlled and any excessive stress on the valve spring to be prevented, when there is such a spring.

In some cases, it is also possible to provide the conduits 6; 6a, 6b with “leaking” valves, for which a bypass conduit is placed parallel to the valve itself. As is well known per se, the “leaking” valves can be used to dissociate the upward and downward flows as well as to adjust the flows.

Determining the configuration and calibration of the flow conduits 6a, 6b between the high-pressure chamber and the low-pressure chamber obviously is related to the engine configuration in which the rod is to operate, and to the selected performance of this engine or expected from it.

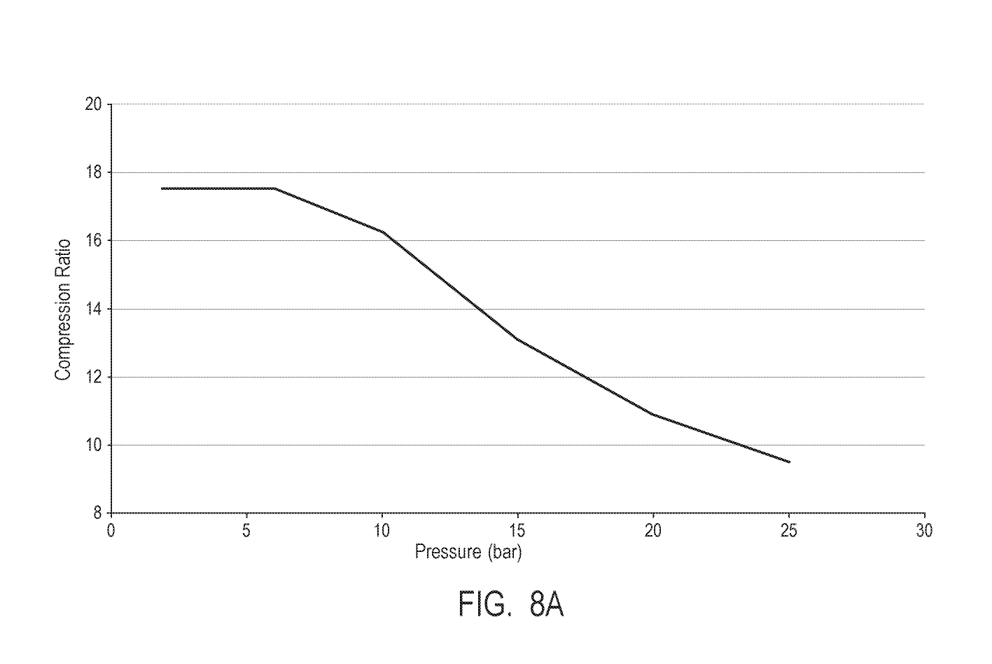

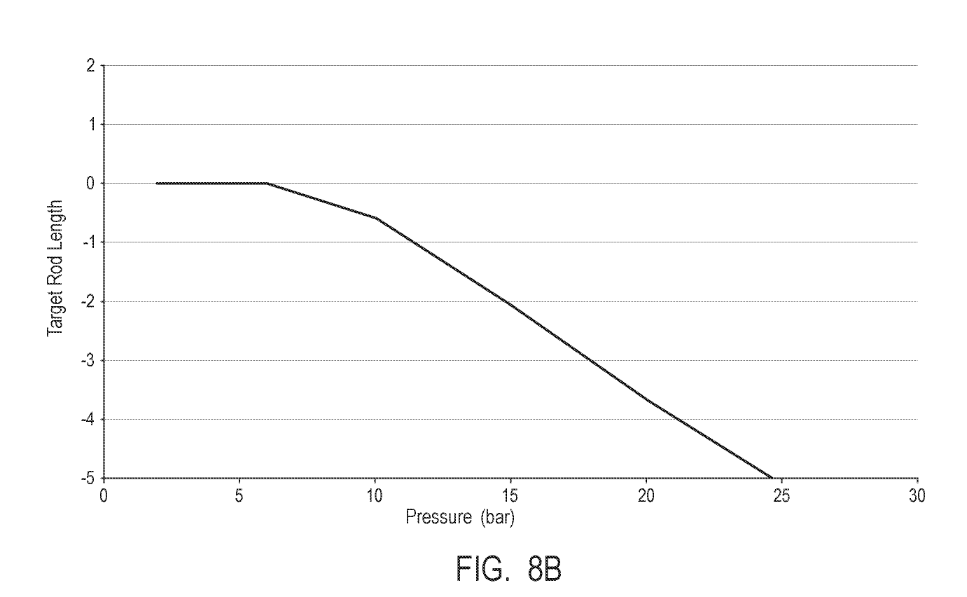

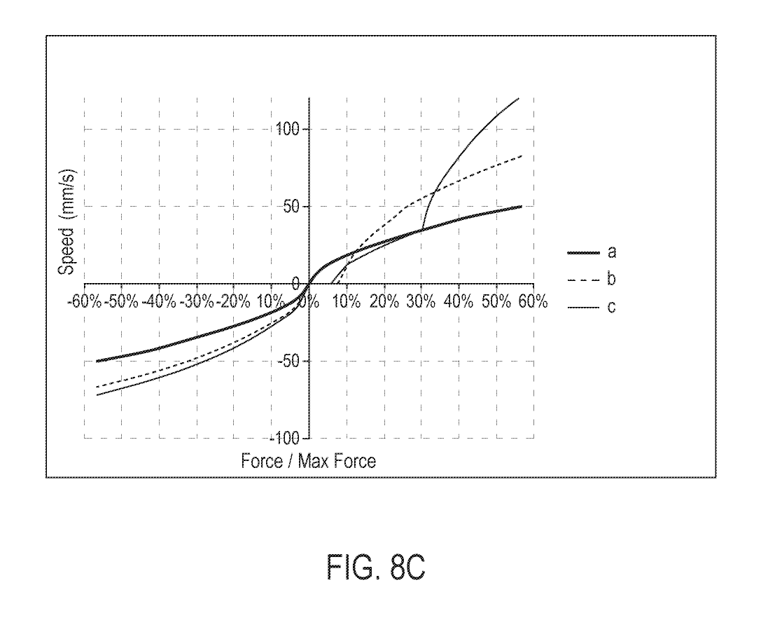

Generally speaking, what is aimed for is to make the operation of the rod (adjustment of the rod length to the engine load, i.e., the average tensile and compressive forces) conform to a predetermined relationship according to the desired characteristics of the engine, for example, to achieve the curve shape shown in FIGS. 8a and 8b. This may involve an arbitration between the complexity of the selected flow configuration (number of conduits, etc.) and its performance. In general terms, the characteristics of the mechanical return means 7 and of the calibrated conduit(s) are so selected that the adjustment of the rod 1 length to the average tensile and compressive forces conforms to a predetermined relationship.

Those skilled in the art can be helped by many common means to achieve this design and/or validation stage. More specifically, this may involve digital simulation and optimization means, or test benches used to apply tensile or compressive stress to the rod according to selected force profiles to qualify its static and dynamic behavior. Among others, these means may be used to ensure that the characteristics of the mechanical return means and of the conduit(s) indeed result in providing the rod with the dynamic behavior of a highly-damped oscillating system.

By way of example, the person skilled in the art may seek to reproduce a type of damping whose law is shown in FIG. 8c. This figure shows the speed of elongation of the rod (in ordinate) according to the amplitude of a constant force that is applied to it (in abscissa). This amplitude is standardized by the maximum force applied to the rod corresponding to the peak of combustion. In FIG. 8c, three laws are shown by way of illustration, for three different rod configurations and according to the disclosure:
(a) rod having a single calibrated conduit;
(b) rod having two calibrated conduits, tensile and compressive respectively, the compressive conduit being provided with a calibrated non-return valve;
(c) rod having three calibrated conduits, one tensile conduit and two compressive conduits, each of the compressive conduits being provided with a calibrated non-return valve.

These damping laws are inter alia characterized by a travelling speed ranging from 30 to 200 mm/s when the applied force is equal to 50% of the maximum visible force on the rod.

A speed of the order of 30 mm/s ensures that a system is achieved with few oscillations of the length of the rod around its balance position during an engine cycle, but its consequence is that the variation in compression ratio is slower when the engine load varies. Conversely, a speed of the order of 200 mm/s makes it possible to obtain a quick variation in compression ratio when the load varies, but it may cause the appearance of oscillations of the length of rod around its balance position. The presence of one or a plurality of calibrated non-return valves makes it possible to establish a behavior law achieving a better compromise between the oscillations of the length of the rod and the reactivity to changes in compression ratio.

Optionally, the rod 1 may include a target (e.g., a magnetic body) used to detect its passage in front of a sensor placed opposite it in the engine or integrated in the crankcase (e.g., a Hall effect sensor). A system for determining the length of the rod 1 during its operation is thus established. One may alternatively prefer the known solution in document DE102009013323.

In general terms, the rod 1 and/or the engine in which the rod is to operate will advantageously be provided with a device for determining the compression ratio, this information being useful to control engine components. For this purpose, the engine or the device in which the rod 1 is to operate may advantageously be equipped with the necessary sensors, a computer and associated programs used to perform the determination, and for it to be taken into account when controlling other engine components. This may, for example, be the known solution in the aforementioned document or the target and the sensor forming the system for determining the length of the rod 1.

### EXAMPLES

By way of example, the following paragraphs present various solutions of rods according to the disclosure and that are particularly suitable for operation in a combustion engine having the following characteristics:
diameter of the combustion piston: 75 mm;
stroke: 84 mm;
three-cylinder engine with a displacement of 1,113 cc; and
maximum load: 25 bar of MEP (mean effective pressure) at a maximum combustion pressure of 130b.

FIG. 8a shows an engine load—target compression ratio behavior law for this engine. As can be seen in FIG. 8b, this law results in a maximum rod travel of 4 mm between the maximum compression ratio and the minimum compression ratio.

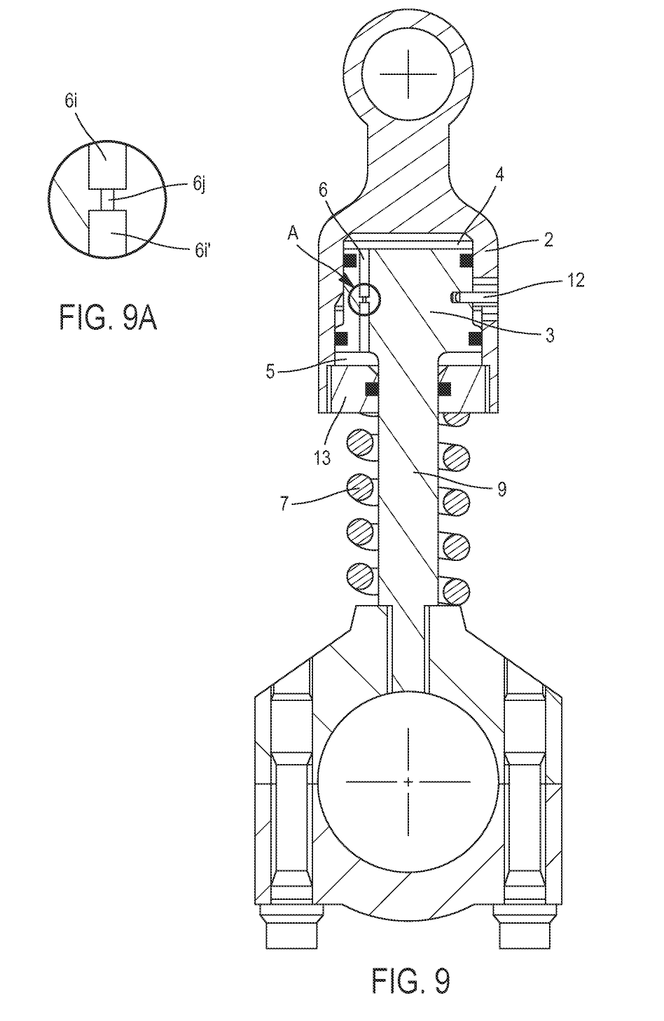

FIG. 9 shows a first example of a rod 1 according to the disclosure and seeking to reproduce the behavior law of FIGS. 8a and 8b.

In the rod 1 of FIG. 9, the cylinder 2 of circular cross section is rigidly connected with the base of the rod and the piston 3 is associated with the head of the rod via its shaft 9.

The interaxial distance of the rod 1 is 150 mm, when it is in its nominal position and of the order of 146 mm when it is in its compressed position, in abutment.

The opening of the cylinder 2 is closed by a cover 13, which can be screwed onto the cylinder 2, to define the low-pressure chamber 5 in the cylinder 2 together with the piston 3. As for the bottom of the cylinder 2, it defines the low-pressure chamber 5 together with the piston 3. The respective dimensions of the cylinder 2 and of the piston 3 enable a rod travel of 4 mm between its mechanical stops formed by the bottom of the cylinder 2 and the cover 13. This rod 1 configuration respectively achieves a minimum compression ratio of 10.3 and a maximum compression ratio of 17.6 when placed in the engine described above.

Similarly to what has been described in connection with FIG. 7b, the rod has a double-stage piston formed by the shoulder 3c. The high-pressure chamber 4 has a diameter of 26.5 mm, which represents a “useful” surface (i.e., the surface projected onto the plane perpendicular to the piston travel axis) of the fluid on the piston 3 of 552 mm². The low-pressure hydraulic chamber 5 has an internal diameter of 30 mm, and the shaft 9 has a circular cross section and is 14 mm in diameter. As a result, the useful surface of the fluid in this chamber on the piston 3 is 553 mm², thus almost identical to that of the high-pressure hydraulic chamber 4. The condition of equivalent cross section is indeed met.

In the piston 3, an indexing means in the form of a pin 12 is placed through an oblong opening in the cylinder 2 (whose length extends in the longitudinal direction of the rod 1) in order to avoid the rotation of the piston 3 while allowing it to slide.

A spring is placed between the base and the head of the rod, so as to apply a return force to the rod 1. In this specific example, the spring has a stiffness of 454 N/mm and it applies a pre-loading force of 1266 N.

The rod 1 shown in FIG. 9 is particularly simple and has a single calibrated conduit 6 with an inner diameter of 0.44 mm to enable the transfer of the hydraulic fluid from one chamber to the other under the effect of tensile and compressive forces exerted on the rod 1. In the example reproduced in this figure, and as shown in more detail in FIG. 9a, the conduit 6 consists of two end segments 6i and 6i′ whose cross section has a diameter of the order of 4 mm and of a central segment 6j 1 mm in length and with a cross section of 0.44 mm. This configuration forms a precisely calibrated conduit and it can be determined that the flow law is of a “turbulent” type under the operating conditions of the engine.

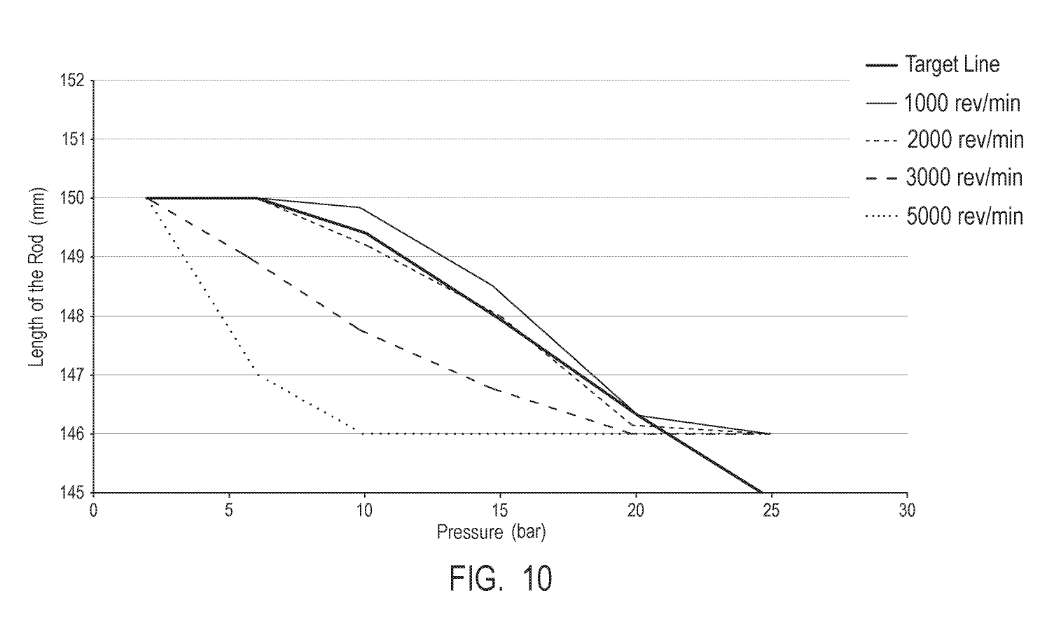

FIG. 10 shows the behavior of the rod when it is put into operation in the engine whose characteristics have been specified above. It is observed that the expected behavior law can be followed with good accuracy at low engine speeds. However, at higher engine speeds, and although the overall behavior is quite acceptable and functional, it departs from the desired target behavior. In all cases, it is deduced from the curve shown in FIG. 10 that the length of the rod 1 is well adjusted according to the average forces that are applied to it. Furthermore, since the hydraulic chambers 4, 5 and the piston 3 in this example are configured to have equivalent cross sections, the behavior (rod length-load law) is essentially independent of the temperature of the hydraulic fluid.

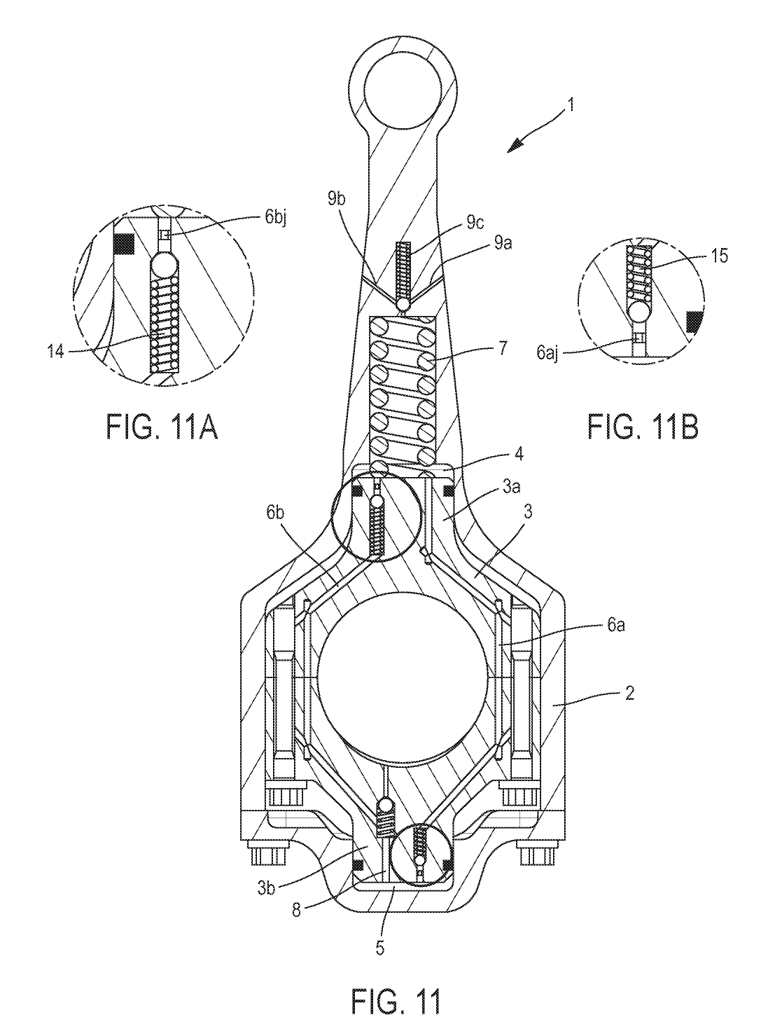

FIG. 11 shows a second example of a rod 1 according to the disclosure and seeking to reproduce the behavior law of FIGS. 8a and 8b. The interaxial distance values in this second example are identical to those of the first example which has just been described.

In this second example, the low- and high-pressure hydraulic chambers 5, 4 are placed on either side of the head of the rod. The cylinder 2 extends partly into the base of the rod and partly into the cap of the rod, each of these parts having a circular cross section of 23.5 mm in diameter. As for the piston 3, it consists of two parts 3a and 3b having the same cross section, respectively cooperating with the cylinder at the base of the rod and at its cap. This configuration obviously meets the equivalent cross section condition.

In this second example, the spring 7 is placed inside the rod 1, which has a particularly significant advantage in terms of space requirement, inside a bore formed in the bottom of the high-pressure hydraulic chamber 4. The spring rests on the bottom of this bore and, at the other end, on the exposed surface of the piston 3a, to exert its return force. It has a stiffness of 427 N/mm and exerts a pre-loading force of 904 N.

The base of the rod has two conduits 9a, 9b and a pressure limiter 9c forming means 9 for discharging any excess pressure that may arise in the high-pressure chamber 4. The piston 3 is also provided with a means 8 for filling the low-pressure hydraulic chamber 5 with hydraulic fluid.

The piston 3 is also provided with a first compressive conduit 6b having (as shown in more detail in FIG. 11a) a diameter of 0.43 mm at a central section 6bj, this section having a length of 1 mm, and a valve 14 calibrated to an opening pressure of 102.9 bar. As explained above, the presence of this calibrated valve 14 makes it possible to limit the size and the stiffness of the spring 7, which is much smaller in size than in the preceding example, and to place it inside the base of the rod.

The piston also has a second tensile conduit 6a (shown in greater detail in FIG. 11b), having an orifice of 0.4 mm in diameter at a central section 6aj; and a calibrated valve 15 whose opening pressure is set to 0.7 bar.

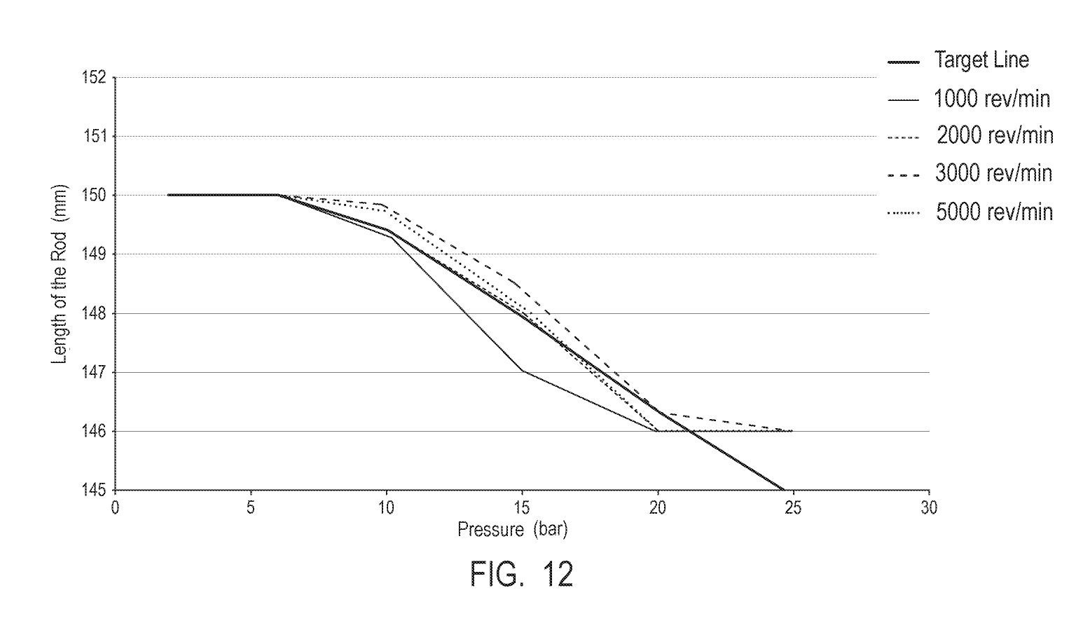

FIG. 12 shows the behavior of the rod of the second example when it is put into operation in the engine whose characteristics have been specified above. It is observed that the expected behavior law can be followed with good accuracy regardless of the engine speed. Furthermore, since the hydraulic chambers 4, 5 and the piston 3 are configured to have equivalent cross sections and the configuration of the conduits 6a, 6b allows a “turbulent” flow of the hydraulic fluid under the operating conditions of the engine, the behavior is essentially independent of the temperature of the hydraulic fluid.

1.-22. (canceled)

23. A variable compression ratio engine, comprising:
a rod having a nominal length, the rod being subjected to tensile and compressive forces along its longitudinal axis during operation of the engine, the rod having a first end and a second end;
a cylinder rigidly connected with the first end of the rod;
a piston rigidly connected with the second end of the rod, the piston being movable in the cylinder and defining a first hydraulic high pressure chamber in the cylinder capable of transmitting compression forces and a second hydraulic low pressure chamber in the cylinder capable of transmitting tensile forces, the low pressure chamber and the high pressure chamber having equivalent cross sections;
at least one conduit configured to enable hydraulic fluid to flow between the low pressure chamber and the high pressure chamber; and
a mechanical return device tending to bring the rod back to a nominal length of the rod.

24. The engine of claim 23, wherein the cylinder has a circular cross section and the cylinder and/or the piston is provided with a means for rotational indexing of the piston with respect to the cylinder.

25. The engine of claim 23, wherein the cylinder has an oval cross section.

26. The engine of claim 23, wherein the mechanical return device comprises a spring.

27. The engine of claim 26, wherein the spring is located in the high pressure chamber.

28. The engine of claim 26, wherein the spring is preloaded.

29. The engine of claim 23, further comprising filling means for filling the cylinder with a hydraulic fluid.

30. The engine of claim 29, wherein the filling means are arranged so as to introduce the hydraulic fluid into the low pressure chamber.

31. The engine of claim 23, further comprising means for discharging any excess of hydraulic fluid in the cylinder in order to limit the pressure developing within the cylinder.

32. The engine of claim 23, wherein the at least one conduit extends through the piston.

33. The engine of claim 23, wherein the at least one conduit extends through the cylinder.

34. The engine of claim 23, wherein the at least one conduit comprises clearance between the piston and the cylinder.

35. The engine of claim 23, wherein the at least one conduit comprises:
a first tensile conduit through which the hydraulic fluid may only flow from the low pressure chamber to the high pressure chamber; and
a second compression conduit through which the hydraulic fluid may only flow from the high pressure chamber to the low pressure chamber.

36. The engine of claim 35, wherein the second compression conduit only allows the hydraulic fluid to flow through the second compression conduit when a pressure in the high pressure chamber exceeds a pressure in the low pressure chamber by a threshold value.

37. The engine of claim 35, further comprising at least one additional compression conduit through which the hydraulic fluid may only flow from the high pressure chamber to the low pressure chamber.

38. The engine of claim 23, wherein the at least one conduit is or are configured to promote a turbulent hydraulic flow.

39. The engine of claim 23, further comprising at least one valve comprising a movable part whose direction of mobility is parallel to a base and head axes of the rod.

40. The engine of claim 23, further comprising at least one valve comprising a movable part whose direction of mobility is located in a plane comprising the main and transverse axes of the rod, the movable part of the valve having a predetermined mass.

41. The engine of claim 23, wherein the mechanical return device and the at least one conduit are configured such that the rod operates as a damped oscillating system during operation of the engine.

42. The engine of claim 23, further comprising a device for determining the compression ratio of the engine.

43. The engine of claim 42, wherein the device for determining the compression ratio of the engine comprises a target arranged on the variable-length rod and a sensor placed opposite the engine.
